(19) United States
(12) Patent Application Publication
(10) Pub. No.: US 2011/0247249 A1
(43) Pub. Date: Oct. 13, 2011

(54) DOUBLE DISPLAY STRUCTURE

(75) Inventor: XIANG CAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/790,860

(22) Filed: May 31, 2010

(30) Foreign Application Priority Data
Apr. 9, 2010 (CN) 201010143482.8

(51) Int. Cl. G09F 11/30

(52) U.S. Cl. 40/446

(57) ABSTRACT

A double display structure includes a first display, a second display, and a sliding member. The sliding member slidably mounts the first display on the second display. The sliding member includes a guiding portion and a slide interchangeably mounted on the first display and the second display. The guiding portion is slid along the slide so that the first display slides with respect to the second display along a first direction to expose the second display. The first display and the second display can be viewed side by side.

### BACKGROUND

1. Technical Field

The present disclosure relates to a double display structure.

2. Description of Related Art

Having only one display to view data or images may not satisfy the needs of certain users. Users may need to work with a multitude of windows spanning across multiple applications. In this situation, the user must always switch from one window to another rather than view many windows at once. It can be inconvenient and time-consuming for users.

### BRIEF DESCRIPTION OF THE DRAWINGS

FIG. 1 is an exploded view of a double display structure in accordance with an exemplary embodiment.

FIG. 2 is similar to FIG. 1, but viewed from another aspect.

FIG. 3 is an assembled view of the double display structure of FIG. 1 in a single display viewing state.

FIG. 4 is similar to FIG. 3 but in a double display viewing state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

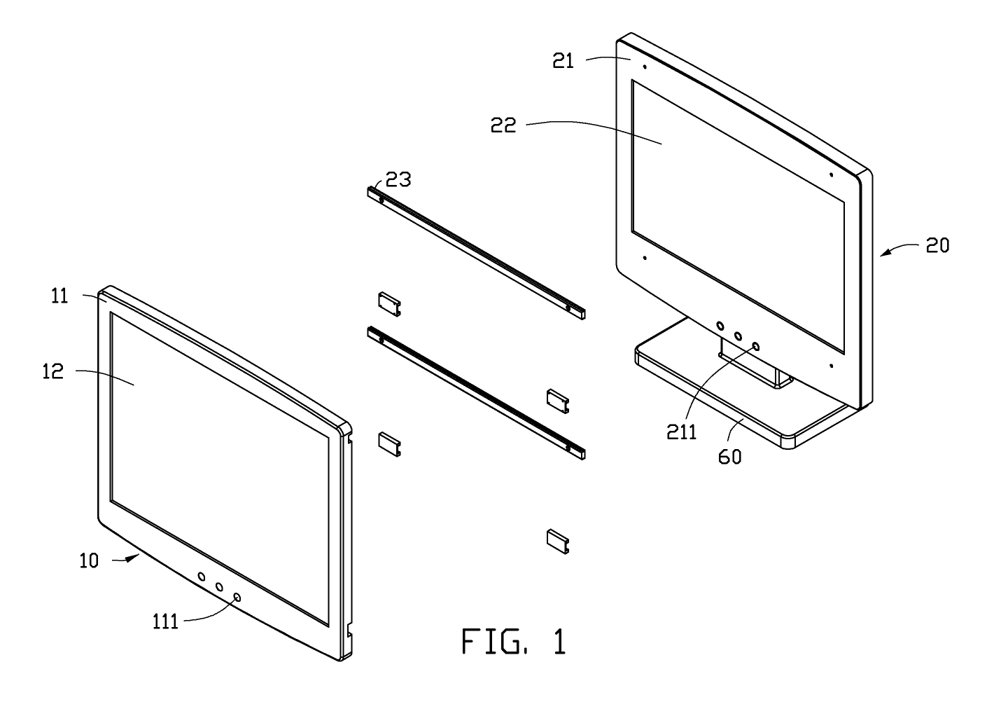

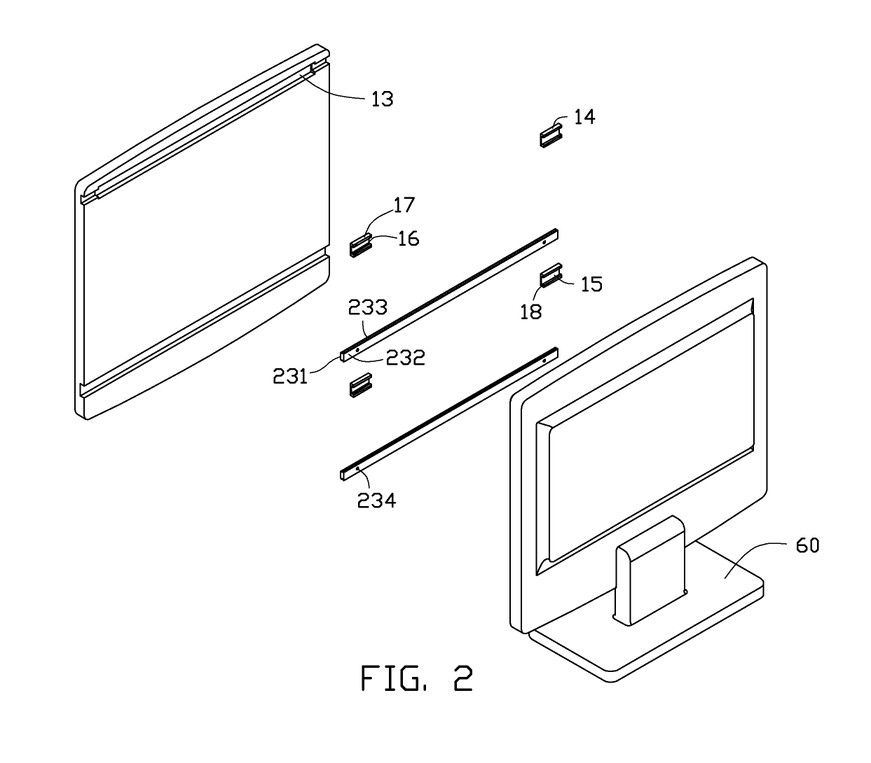

Referring to FIGS. 1-2, a double display structure includes a first display 10 and a second display 20 both mounted on a bracket 60. The first display 10 includes a first plate 11 and a first screen 12 secured on a middle portion of the first plate 11. Two parallel grooves 13 are defined in a back portion of the first display 10. A plurality of first buttons 111 is disposed on the first plate 11 below the first screen 12. The first buttons 111 can be control buttons for the first display 10.

A plurality of guiding portions 14 are fixed in the grooves 13. Each guiding portion 14 includes a body 16 and two flanges 17 bending from two ends of the body 16. A receiving space 15 is formed between two flanges 17 and the body 16. Two hooks 18 respectively bend from two flanges 17 towards each other.

The second display 20 includes a second plate 21 and a second screen 22 secured on a middle portion of the second plate 21. Two parallel slides 23 are mounted on the second plate 21. The guiding portions 14 are fixed on the back portion of the first display 10, and the slides 23 are installed on a front portion of the second display 20. A plurality of second buttons 211 is disposed on the second plate 21 below the second screen 22. The second buttons 211 can be control buttons for the second display 20. The first screen 12 and the second screen 22 faces toward the same direction.

The first display 10 and the second display 20 are independent. The first buttons 111 can be control buttons for the first display 10. The second buttons 211 can be control buttons for the second display 20. The first display 10 and the second display 20 respectively have interfaces for connecting to power.

Each slide 23 includes a sliding portion 231 and a fixing portion 232. A sliding groove 233 is defined between the sliding portion 231 and the fixing portion 232. The sliding portion 231 slides in the receiving space 15. The hook 14 is inserted in the sliding groove 233. A plurality of holes 234 is defined in the fixing portion 232 to fix the slide 23 on the second display 20 through rivets.

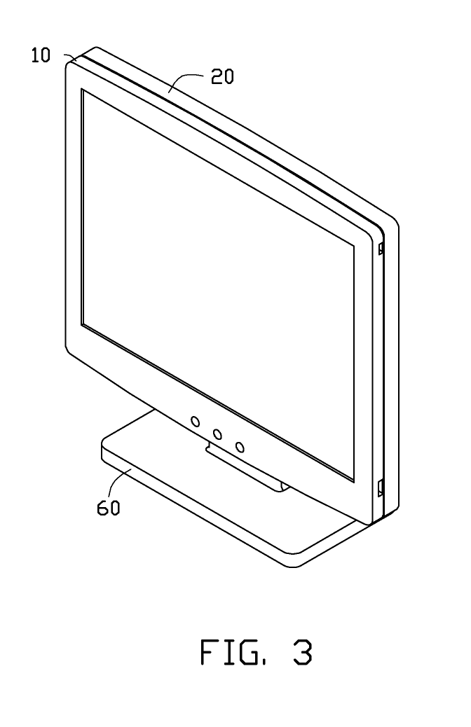

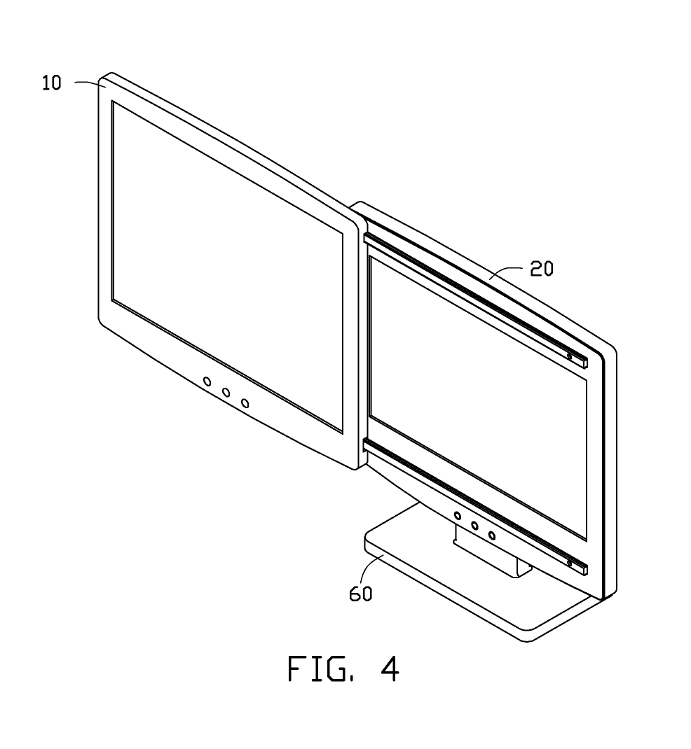

Referring to FIGS. 3-4, in assembly, the guiding portions 14 are fixed in the grooves 13 by rivets. The slides 23 are mounted on the second plate 21. The slides 23 are inserted in the guiding portions 14. The sliding portion 231 slides in the receiving space 15 when the first display 10 slides corresponding to the second display 20.

The first display 10 can be slid along the slides 23 to an extended position revealing the second display 20. A user can simultaneously see the first display 10 and the second display 20 to work conveniently. The guiding portions 14 may be installed on the second display 20, and the slides 23 may be fixed on the first display 10.

The user can use any one of the first display 10 and the second display 20. The first buttons 111 can be control buttons for the first display 10. The second buttons 211 can be control buttons for the second display 20. The first buttons 111 and the second buttons 211 may be a menu button, a brightness/contrast adjusting button, for example.

The double display structure in accordance with a second embodiment will be described in detail below. The slide 23 may be installed in groove 13 of the first display 10. The first display 10 also can slide on the second display 20. The guiding portion 14 is omitted.

The double display structure in accordance with a third embodiment will be described in detail below. An end of the slide 23 may have a first ring and a corresponding end of the first plate 11 may have a second ring. A lock may lock on the first ring and the second ring. Thus, the double display can be locked when the user is away. The lock can protect the content shown on the second display 20.

When the user uses the double display structure, the first display 10 and the second display 20 can display different content thereon. If the user has some secret files, the secret files can be shown on the second display 20. The first display 10 is located in front of the second display 20. That is, the first display 10 can block the secret files shown on the second display 20. Thus, nobody see the secret files shown on the second display 20. The user sees the secret files shown on the second display 20 in necessary.

One of the important functions of the double display structure is to increase the display length. If there is only one display, the display length is a width of the display. In the double display structure, the display length is twice than the one display. For example, if the first display 10 shows too much content, the user need pull a scrollbar to see the content. It is not convenient for the user. The user can simultaneously use the first display 10 and the second display 20 to see the connecting content. The first display 10 can show one part of the content and the second display 20 can show the other part of the content.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A double display structure, comprising:
a first display;
a second display; and
a sliding member slidably mounting the first display on the second display, the sliding member comprising a guiding portion and a slide interchangeably mounted on the first display and the second display;
wherein the guiding portion is slid along the slide so that the first display slides with respect to the second display along a first direction to which the slide extends causing the first display and the second display to show side by side.

2. The double display structure of claim 1, wherein the first display and the second display both comprise screens facing toward the same direction.

3. The double display structure of claim 1, wherein a receiving space is defined in the guiding portion to receive the slide.

4. The double display structure of claim 3, wherein the guiding portion comprises a body and two flanges bending from the body, the receiving space is formed between the body and two flanges.

5. The double display structure of claim 1, wherein a groove is defined in the first display to receive the guiding portion.

6. The double display structure of claim 1, wherein the guiding portion is set on a back portion of the first display, and the slide is set on a front portion of the second display.

7. A double display structure, comprising:
a first display;
a second display; and
a sliding member slidably mounting the first display on the second display, wherein the first display slides along the sliding member corresponding to the second display, the first display slides toward a first direction parallel to a plane of the second display.

8. The double display structure of claim 7, wherein the sliding member comprises a guiding portion and a slide interchangeably mounted on the first display and the second display, the guiding portion is slid along the slide so that the first display slides relative to the second display.

9. The double display structure of claim 8, wherein a receiving space is defined in the guiding portion to receive the slide.

10. The double display structure of claim 9, wherein the guiding portion comprises a body and two flanges bending from the body, the receiving space is formed between the body and two flanges.

11. The double display structure of claim 8, wherein a groove is defined in the first display to receive the guiding portion.

12. The double display structure of claim 8, wherein the guiding portion is set on a back portion of the first display, and the slide is set on a front portion of the second display.

13. The double display structure of claim 7, wherein the first display and the second display both comprise screens facing toward the same direction.
